(19) United States
(12) Patent Application Publication
(10) Pub. No.: US 2012/0280085 A1
(43) Pub. Date: Nov. 8, 2012

(54) EXTRACTION FORCE TRANSFER COUPLING AND EXTRACTION PARACHUTE JETTISON SYSTEM

(76) Inventors: Robert James Sinclair, Costa Mesa, CA (US); John Allen Barnett, Rancho Santa Margarita, CA (US); Robert Kelly Bresnahan Schauer, Westminster, CA (US)

(21) Appl. No.: 13/102,499

(22) Filed: May 6, 2011

(51) Int. Cl. B64D 1/12

(52) U.S. Cl. 244/137.3

(57) ABSTRACT

A system including an extraction force transfer coupling link assembly is provided that extracts a cargo from an airborne aircraft with an extraction parachute and then deploys the cargo with a descent parachute. During a normal extraction the link assembly transfers a force from an extraction line to a deployment lanyard that deploys a descent parachute. In the event of a failed extraction, the assembly severs the deployment lanyard and jettisons the extraction parachute. The extraction force transfer coupling link assembly includes an ultra high molecular weight polyethylene rope that has one end of the deployment lanyard braided with the extraction line. The rope acts as both the extraction line for the cargo and the deployment lanyard for the descent parachute. By virtue of the ability to use a single rope, the link assembly is of simple construction and employs pyrotechnic cutters to effect the release of the extraction line and deployment lanyard rather than conventional mechanical interlocks.

### BACKGROUND OF THE INVENTION

1. Field of the Invention

The present invention relates generally to a system that extracts a cargo from an airborne aircraft and then deploys the cargo parachute. More specifically, the present invention relates to a system that during a normal extraction transfers a force from an extraction parachute to deploy a descent parachute and that, in the event of a failed extraction, jettisons the extraction parachute.

2. Description of the Prior Art

During a typical operation for the extraction and deployment of cargo from an airborne aircraft, a drogue parachute first deploys an extraction parachute which acts to extract the cargo from the aircraft. As the load leaves the ramp of the aircraft, the connection between the extraction parachute and the cargo is released. As a result, force from the extraction parachute is transferred to extract the descent parachute which, once deployed, carries the cargo during the descent. A conventional extraction assembly with cargo is illustrated in FIG. 1.

During a normal deployment, only the connection between the cargo and the extraction parachute is released. However, an emergency situation can arise during a failed extraction, such as when the cargo platform becomes immobile or when the extraction parachute does not disconnect from the cargo. In this situation, the connections to both the extraction parachute and the descent parachute must be severed and the cargo is not deployed.

Various conventional approaches are known for separating an extraction parachute from a deploying cargo during a failed extraction. For example, one approach involves manually cutting the lines that connect the extraction parachute to the cargo so as to release the parachute. The manual approach, however, can pose a substantial safety risk to aircraft personnel.

U.S. Pat. No. 5,816,535 discloses an Emergency Cargo Extraction Parachute Jettison System that in one configuration eliminates the need to manually effect the release. The system includes a load transfer coupling attached to each extraction parachute for releasing the extraction parachute from the cargo container upon receipt of electrical power. A first circuit, coupled to the load transfer coupling, provides electrical power to the load transfer coupling of the next ejectable cargo container upon receiving an actuation signal to release the extraction parachute. A second circuit is used to sense when each of the plurality of cargo containers has been ejected from the aircraft and to provide the cargo container ejection signal to the first circuit upon such ejection. The actuation signal is provided to the first circuit if the ejection signal is not received within a specific time after initiation of the cargo ejection sequence. A third circuit is used to manually provide the actuation signal to the first circuit to enable immediate jettison of the extraction parachute.

The U.S. Government uses a standard mechanical release Extraction Force Transfer Coupling (EFTC) as shown in FIG. 2. As indicated above, the EFTC is released in response to movement of an actuator arm 4 when the load leaves the ramp of the aircraft. Upon such release, the extraction line 6, which is attached to a three-point link 8, deploys the descent parachute. While a workable system, the U.S. Army EFTC system is limited to a 42,000 lb payload extracted weight for standard airdrop at low altitudes.

The U.S. Army has also adapted an Extraction Parachute Jettison Device (EPJD) into the EFTC for payloads with a maximum extracted weight of 21,000 lb. The EPJD, however, does not incorporate any redundancy in the release unit. In addition, the Army's EFTC and EPJD are installed in series and, because of the three-point link design, necessarily include multiple mechanical assemblies.

Finally, the U.S. Army's EFTC is used with a nylon concentric loop extraction line that varies in length and number of plies depending on the extraction weight and type of aircraft being used. This nylon line stretches as much as 25-30%, resulting in the storage of a considerable amount of energy during the extraction event. Consequently, the nylon line has a tendency to rebound or send a standing wave back into the aircraft during the extraction parachute deployment.

### SUMMARY OF THE INVENTION

In order to overcome the above-described drawbacks of the prior art devices, the present invention provides an electronically controlled system that extracts cargo from an airborne aircraft with an extraction parachute and then deploys the cargo with a descent parachute. During a normal extraction, the extraction parachute pulls the cargo from the aircraft via a cargo extraction line. Upon severing of the extraction line, a deployment lanyard subsequently deploys a descent parachute. In the event of a failed extraction, the assembly severs both the extraction line and the deployment lanyard so as to jettison the extraction parachute.

By combining both EFTC and EPJD capabilities into a single assembly, the present invention facilitates the extraction of payloads ranging from 5,000 to 100,000 lb at both low and high altitudes.

The present invention also includes an ultra high molecular weight polyethylene rope that is a braided assembly of the extraction line and the deployment lanyard. The single piece rope serves as both the extraction line for the cargo and the deployment lanyard for the descent parachute. The rope exhibits very low elongation under load, and therefore does not exhibit the standing wave phenomenon associated with conventional nylon extraction lines.

Another feature of the present invention is its mechanical simplicity. By virtue of the ability to use a single rope for both the extraction and deployment functions, the link assembly is of relatively simple construction and avoids use of the conventional three-point link.

Still another feature of the present invention is that by virtue of using the ultra high molecular weight polyethylene rope, the system can employ pyrotechnic cutters to effect the release of the extraction line and deployment lanyard rather than conventional mechanical interlocks. Pyrotechnic cutters are far more efficient and reliable than mechanical assemblies, especially when the tension in the load member is relatively high. Therefore, the present invention is capable of reliably deploying loads that are substantially heavier than the loads associated with conventional EFTC systems.

Yet another feature of the present invention is the ability to vary the time delay of the extraction force transfer coupling, as well as the ability to jettison the extraction parachute in any type of emergency.

Accordingly, it is an object of the present invention to provide an electronically controlled system that extracts a cargo from an airborne aircraft with an extraction parachute and then deploys the cargo with a descent parachute, while also having the capability to sever both the extraction line and the deployment lanyard to jettison the extraction parachute.

Another object of the present invention is to combine EFTC and EPJD capabilities into a single assembly.

Yet another object of the present invention is to provide a system that uses a single rope for both the extraction and deployment functions, thereby providing a link assembly that is of simpler construction and more reliable than the conventional three-point link.

Still another object of the present invention is to provide an ultra high molecular weight polyethylene rope that can be severed using pyrotechnic cutters and which exhibits very low elongation under load.

A further object of the present invention is to provide an EFTC assembly having variable time delay capability.

A still further object of the present invention to be specifically enumerated herein is to provide an extraction force transfer coupling and parachute jettison system in accordance with the preceding objects that will conform to conventional forms of manufacture, be of relatively simple construction and easy to use so as to provide a system that will be economically feasible, long lasting, durable in service, relatively trouble free in operation, and a general improvement in the art.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is an illustration of a conventional extraction force transfer coupling and extraction parachute jettison system.

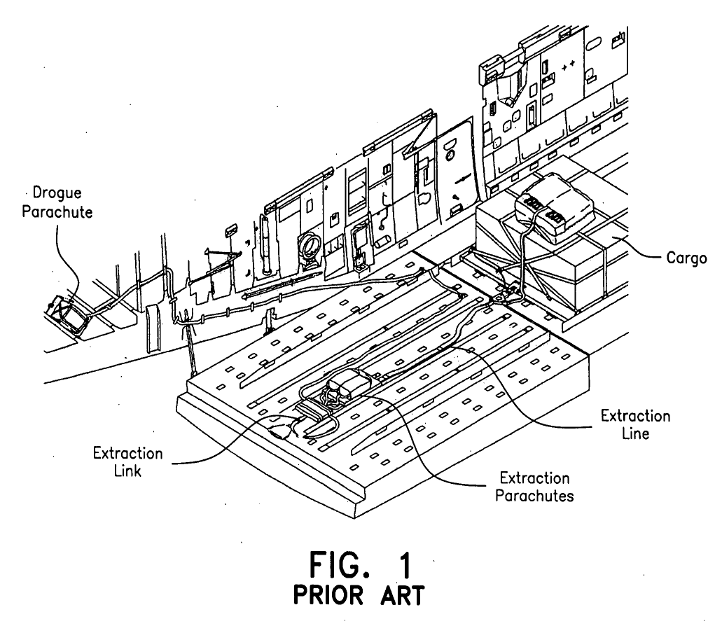

FIG. 2 is an illustration of a conventional three-point link used in the system of FIG. 1.

FIG. 3 is a perspective view illustrating an extraction force transfer coupling and extraction parachute jettison system in accordance with the present invention.

FIG. 4 is a perspective view illustrating an extraction line and deployment lanyard rope and EFTC link assembly coupled to an extraction parachute in accordance with the present invention.

FIG. 4A is an enlarged view of portion 4A of FIG. 4.

FIG. 5 is a perspective view illustrating an EFTC assembly in accordance with the present invention prior to deployment of an extraction parachute.

FIG. 6 is a perspective view illustrating the EFTC assembly of FIG. 5 after the extraction line has been cut and with the deployment lanyard remaining intact as in a normal operation.

FIG. 7 is a perspective view illustrating the EFTC assembly of FIG. 5 during a parachute jettison operation in which both the extraction line and deployment lanyard have been cut.

FIG. 8 is a block diagram illustrating analog control circuitry for the extraction force transfer coupling in accordance with the present invention.

FIG. 9 is a block diagram illustrating microprocessor-controlled control circuitry for the extraction force transfer coupling in accordance with the present invention.

FIG. 10 is a flow diagram illustrating the functional flow of the circuitry of FIG. 9.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of constructions, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents which operate in a similar manner to accomplish a similar purpose. Where possible, components of the drawings that are alike are identified by the same reference numbers.

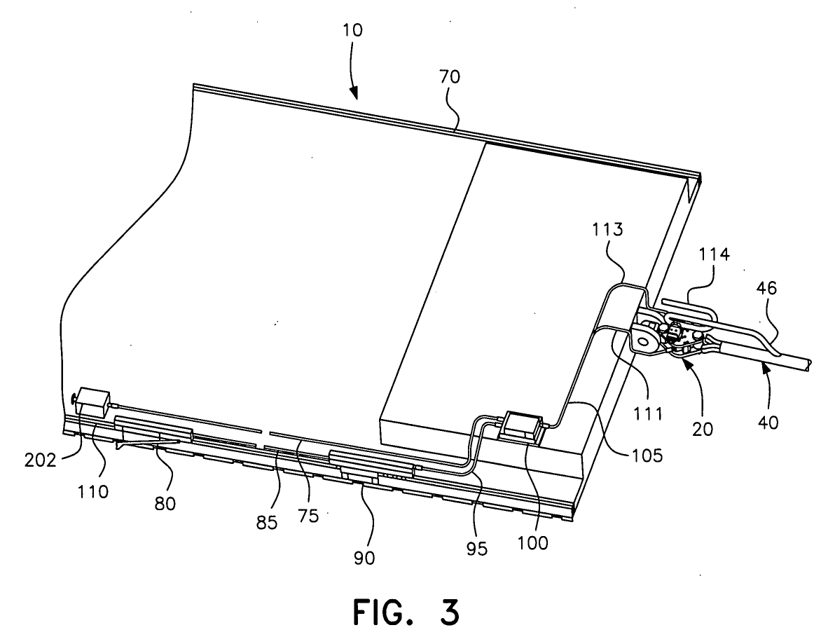

Referring now specifically to FIG. 3 of the drawings, there is illustrated an extraction force transfer coupling (EFTC) and extraction parachute jettison device (EPJD) system, generally designated by the reference numeral 10, in accordance with the present invention. The EFTC acts to transfer the force initially applied to the extraction line by the extraction parachute, which is used to extract the platform from the aircraft, to the deployment lanyard of the cargo's main descent parachute. The EPJD releases both the extraction line and the deployment lanyard in the case of a failed extraction.

The system 10 includes an EFTC link assembly, generally designated by reference numeral 20, mounted on a load platform 70 and electrically coupled to an electronic control box 100. The electronic control box 100 receives signal inputs from an EFTC switch box 90, which is coupled to an EFTC actuator 80, and from an emergency jettison box 110, all of which are mounted to the platform.

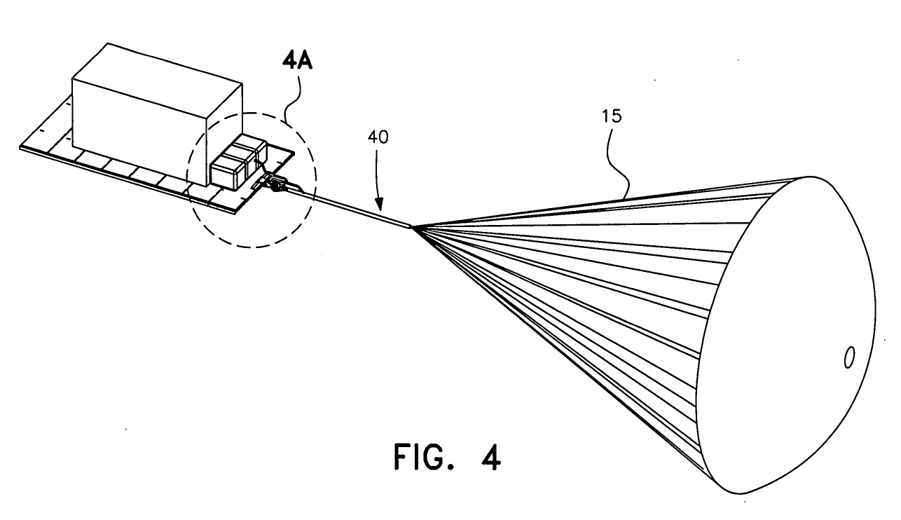

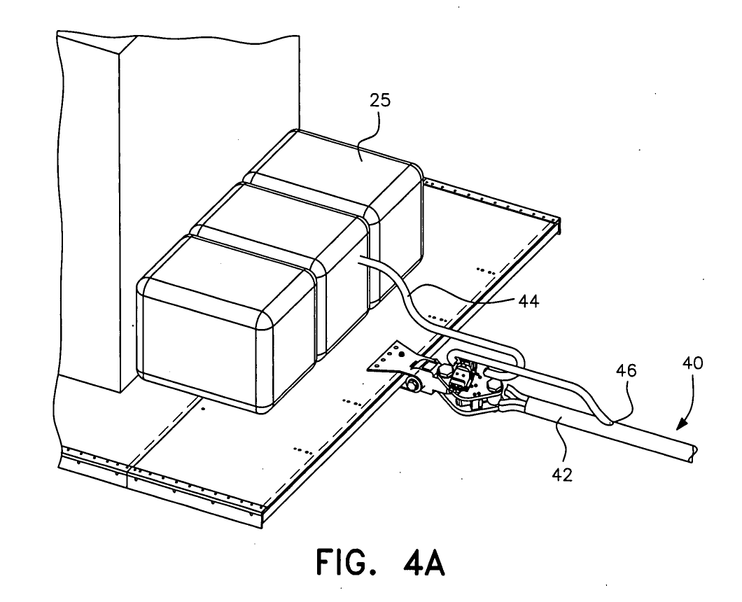

The EFTC link assembly 20 is connected to an extraction parachute 15, as shown in FIG. 4, and to a main deployment parachute 25, as shown in FIG. 4A, by an extraction line and deployment lanyard rope, generally designated by reference numeral 40. As shown in FIG. 4A, the extraction line and deployment lanyard rope 40 includes an extraction line 42 and a deployment lanyard 44 which are joined to one another, preferably by braiding or other highly integrated connection, at a junction 46. The extraction line 42 connects the extraction parachute via the link assembly 20 to the cargo that is to be deployed. The deployment lanyard 44 connects the rope 40 to the descent parachute 25 that, once deployed, carries the deployed cargo to the ground.

The extraction line and deployment lanyard rope 40 is manufactured from a high-tenacity material which reduces the amplitude of the standing wave that is often associated with extraction parachute deployment using conventional extraction line material as previously discussed. A preferred material of construction for the rope 40 is ultra high molecular weight polyethylene (UHMWP). In one preferred embodiment, the rope 40 is made from a UHMWP rope such as the product sold under the trademark PLASMA by Cortland Cable of Cortland, N.Y. The PLASMA rope is constructed of high modulus polyethylene fibers produced by gel spinning ultra high molecular weight polyethylene, and has an excellent strength-to-weight ratio, the highest abrasion resistance of any fiber, and excellent dynamic toughness. The PLASMA rope also exhibits excellent flex fatigue resistance, low resistance to heat, and very low elongation, stretching only approximately 3-5% under load which results in less stored energy and reduced standing wave magnitude.

In a preferred configuration of the extraction line and deployment lanyard rope 40, the extraction line 42 is a 1⅝ inch diameter, twelve strand, PLASMA line, and the deployment lanyard 44 is a 1⅛ inch diameter, twelve strand PLASMA line that is braided into the extraction line 42 at the junction 46. This configuration provides a rope 40 that has an ultimate tensile strength of approximately 295,000 lbs.

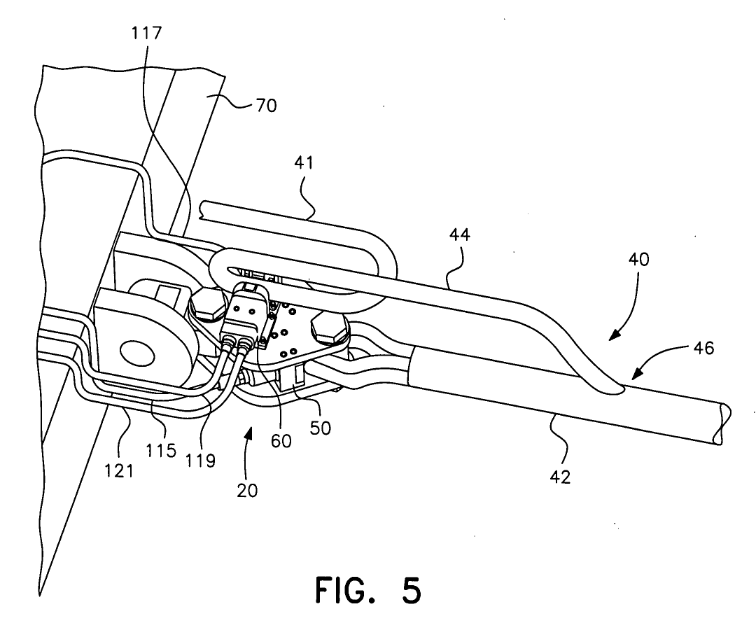

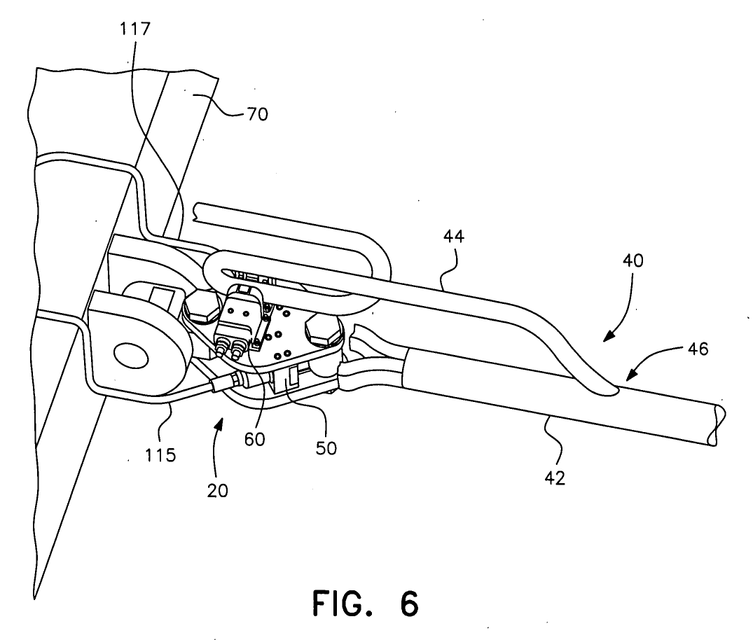

As shown in FIGS. 5, 6 and 7, the EFTC link assembly 20 includes an extraction line pyrotechnic cutter 50 and a deployment lanyard pyrotechnic cutter 60. The extraction line 42 connects to the EFTC link assembly 20 through pyrotechnic cutter 50, and the deployment lanyard 44 connects to the EFTC link assembly 20 through pyrotechnic cutter 60. Preferably, the deployment lanyard 44 has some slack when configured for deployment, such as that provided by loop 41, to prevent the lanyard from being pulled inadvertently. As shown in FIG. 5, pyrotechnic cutter 50, when activated, severs the extraction line 42 while the deployment lanyard remains intact. This occurs during a normal extraction operation.

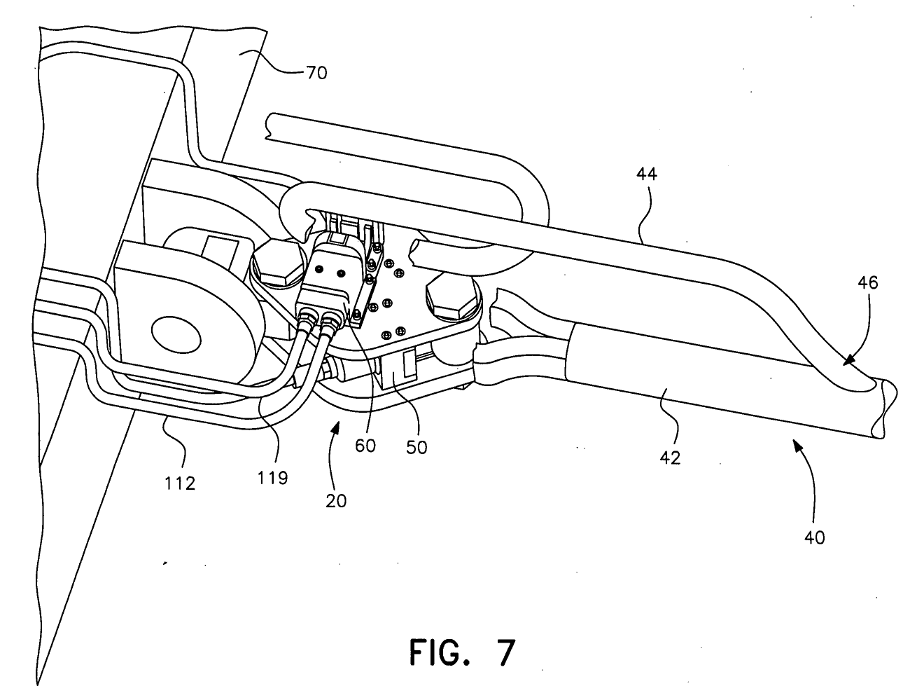

During a failed extraction, however, pyrotechnic cutter 60 is activated. If pyrotechnic cutter 50 has not already been triggered by the EFTC actuator 80, control circuitry activating the pyrotechnic cutter 60 will first trigger the extraction line pyrotechnic cutter 50 to sever the extraction line 42 just before the deployment lanyard 44 is severed. Hence, activation of pyrotechnic cutter 60 effectively results in the severing of both the extraction line and the deployment lanyard, as shown in FIG. 7. Thus, pyrotechnic cutter 60 functions essentially as an extraction parachute jettison device (EPJD) to release the extraction parachute 15 in the event of an emergency or abnormality in parachute deployment.

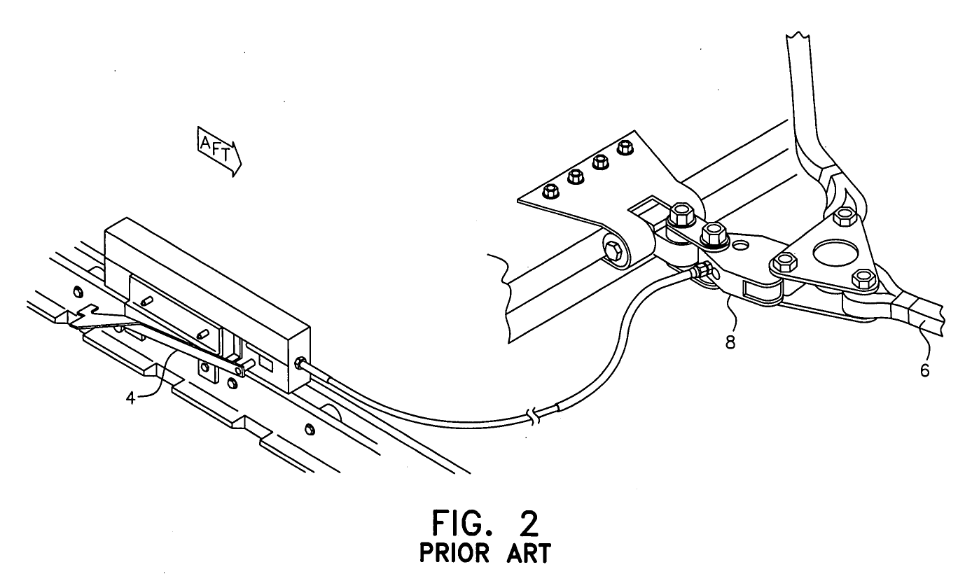

Activation of the pyrotechnic cutter 50 is initiated by the EFTC actuator 80 which is connected to the EFTC switch box 90 via a control cable 85. The actuator 80 includes an actuator arm 4 (see FIG. 2) which, when tipped, results in a signal being sent over the control cable 85 to the switch box 90. The switch box 90 generates an output which is transmitted to the control box 100 over control cable 95. The control box 100 then initiates activation of the link assembly 20 via control cable 105. Control cable 105 provides two inputs 111, 113 to the link assembly, one to initiate severing of the extraction line and the other to initiate severing of the deployment lanyard. In brief, activation of a switch mechanism 202 on the emergency jettison box 110 generates a signal to the control box 100 over control cable 75 which results in activation of the link assembly 20 to sever the deployment lanyard 44.

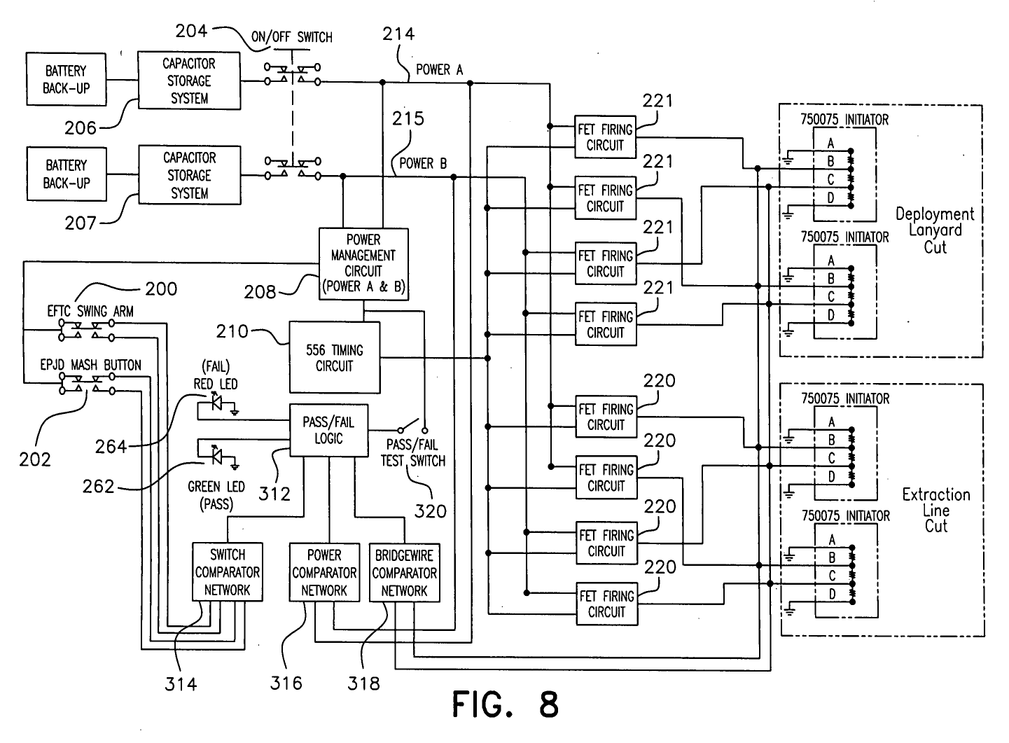

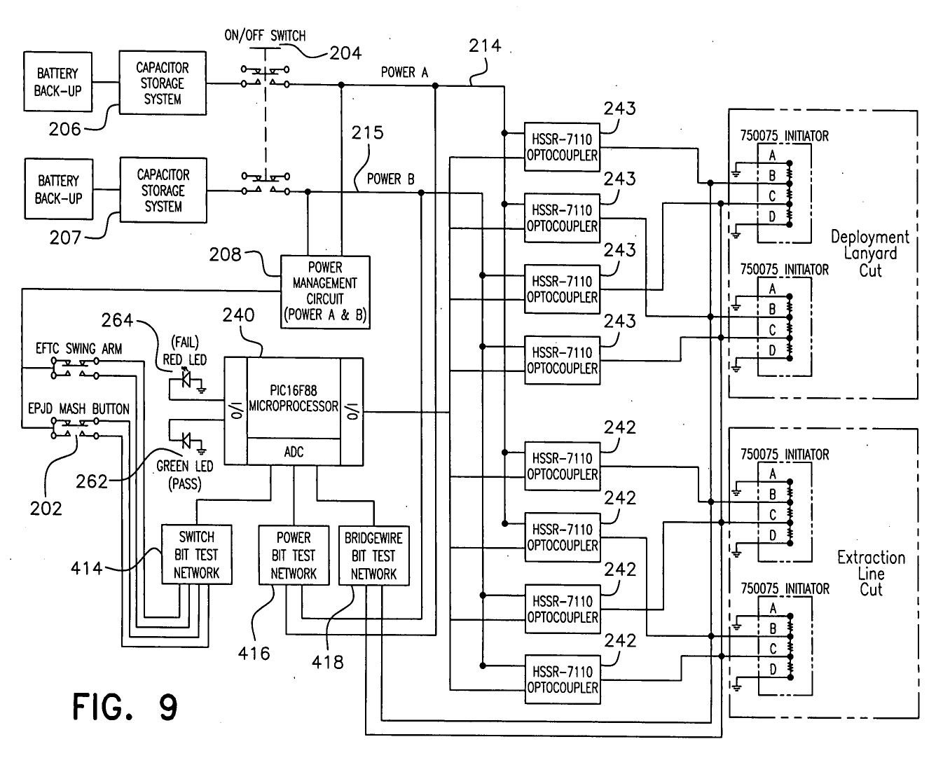

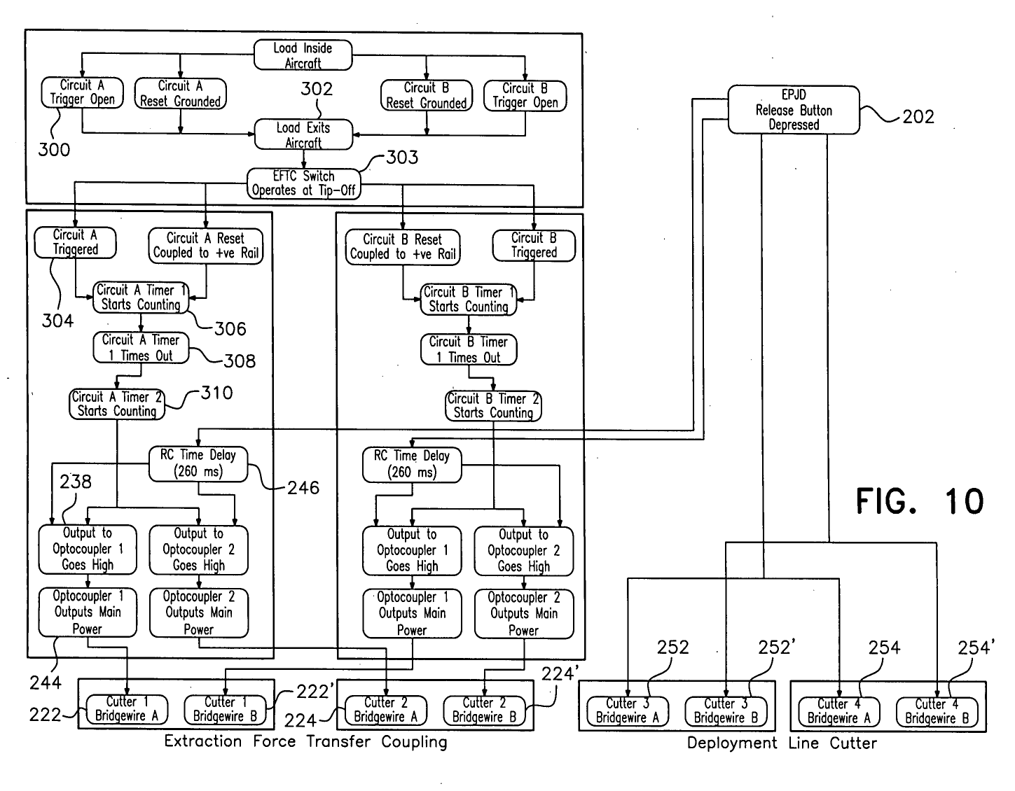

Block diagrams setting forth the transfer coupler control circuitry are provided in FIGS. 8 and 9. FIG. 8 depicts an analog embodiment of the circuitry, while FIG. 9 depicts a microprocessor controlled embodiment thereof. A flow diagram illustrating the functional flow of the circuitry is set forth in FIG. 10.

To operate the control system, power is first switched on via an On/Off switch 204. Two independent power sources 206, 207 provide dual redundancy, with a power management circuit 208 being configured to provide continuous power to vital components of the EFTC such as the timing circuit 210 and the test circuit 312. Upon start up, the power management circuit 208 takes its supply voltage from a power A rail 214 by default. If there is a fault, however, then the power management circuit 208 switches to receive its supply voltage from a power B rail 215. The power rails 214, 215 are constantly monitored and the power management circuit 208 has the ability to switch to either the power A rail 214 or the power B rail 215 should there be a fault.

Assuming a successful start-up, the transfer coupling control circuit enters an operational mode in which the EFTC swing arm 4 and the EPJD activation switch 202 are continuously monitored. For purposes of discussion, the circuit as powered by power A rail 214 is described. However, persons of ordinary skill in the art will recognize the same discussion is equally applicable to the circuit flow as powered by power B rail 215, as shown in parallel on the right-hand side of FIG. 10.

While the cargo load is inside the aircraft, a circuit trigger 300 remains open and the EFTC cannot be activated. Movement 303 of the actuator arm 4 in response to load exit 302 from the aircraft 302, however, activates the EFTC to trigger the circuit 304 which starts a first timer 306 within timing circuit 210.

Once the first timer times out at 308, a second timer within the timing circuit 210 begins at 310. When the second timer times out, the timing circuit 210 produces an output via control lines 115, 117 to a firing circuit 220 to activate the pyrotechnic cutters 50 to sever first and second bridgewires 222, 224 to release the extraction line 42. In the microprocessor-controlled embodiment, the timing circuit 210 is embodied as a microprocessor 240 which provides a high output 238 to a plurality of optocouplers 242 that in turn output main power 244 to the cutters 50 to sever the bridgewires 222, 224.

If the EPJD activation switch 202 is activated, the timing circuit 210 or microprocessor 240 initiates a 250 millisecond time delay 246 before the respective firing circuits 220 or optocouplers 242 activate the pyrotechnic cutters 50. During this delay period, corresponding firing circuits 221 or optocouplers 243 are activated to initiate operation of pyrotechnic cutters 60, via control lines 119, 121, which act to sever third and fourth bridgewires 252, 254 to release the deployment lanyard 44. Following this release, i.e., about 250 milliseconds later, the first and second bridgewires 222, 224 are severed by pyrotechnic cutters 50 to release the extraction line as already discussed.

As shown in FIG. 8, the transfer coupler control circuitry also includes a test circuit 312 including a switch comparator network 314, a power comparator network 316 and a bridgewire comparator network 318. The test circuit 312 allows a system operator, by pressing a pass/fail bit test switch 320 at any time, to carry out a Built In Test (BIT) of the power comparator network 316 to determine whether there is sufficient voltage in both the power A and power B rails. Another BIT then checks the switch comparator network 314 for continuity of both the EFTC swing arm 4 and the EPJD activation switch 202. A final BIT is then performed of the bridgewire comparator network 318 to check the resistance of all eight initiator bridgewires 222, 224, 252, 254, 222′, 224′, 252′, 254′ to ensure that they have the correct resistance and are not open or short circuited. If all three of the aforementioned tests are successful, a green (Pass) Light Emitting Diode (LED) indicator lamp 262 is illuminated. If one of the tests fails, a red (Fail) LED lamp 264 is illuminated. The microprocessor-controlled circuitry with microprocessor 240 performs comparable BIT functions using a switch bit test network 414, a power bit test network 416 and a bridgewire bit test network 418 as shown in FIG. 9.

The present invention provides many advantages over the prior art. To summarize, the rope 40, which is attached to the EFTC link assembly 20 with no mechanically released components, eliminates the need for the traditional three-point link mechanical interlock assembly used in the conventional EFTC system. Thus, the present invention advantageously eliminates many of the mechanical components normally associated with this type of airdrop hardware, reducing cost and simplifying operation. Instead, the system 10 of the present invention employs modern electrical controls combined with pyrotechnic cutter technology that has proved to be highly efficient and reliable. The pyrotechnic cutters 50, 60 are far more reliable than conventional mechanical assemblies, especially when the tension in the load member is relatively high. Therefore, the present invention is capable of reliably deploying loads that are substantially heavier than the loads associated with conventional EFTC systems.

Another advantage of the system 10 according to the present invention is that the extraction line 42, deployment lanyard 44 and extraction parachute rigging/installation will be the same as or similar to that of the current U.S. Army system. In a C-17 or C-130 aircraft, for example, the electronic control system of the present invention can be integrated with the current control system at the loadmaster station, which presently controls the U.S. Army EPJD-light, controller, and platform interfaces.

It is not intended that the present invention be limited to the specific apparatus and methods described herein. The foregoing is considered as illustrative only of the principles of the invention. For example, while the various embodiments of the invention have been described in the context of deploying a single cargo, in another possible embodiment the system described herein can be used to deploy a succession of cargo platforms.

In addition, while the invention has been described in the context of a single extraction parachute and a single descent parachute, in another possible embodiment the system described herein can be used with cargoes requiring a plurality of extraction parachutes and/or a plurality of descent parachutes.

Additionally, while the invention has been described in the context of a rope 40 that is of braided ultra high molecular weight polyethylene construction, in another possible embodiment the rope can be of a different construction as long as it can fulfill the requirements of the service described herein.

Further, numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. An extraction force transfer coupling and extraction parachute jettison assembly adapted for use with an airborne cargo deployment system, comprising:
a combined cargo extraction line and descent parachute deployment lanyard rope adapted to connect to an extraction parachute and to a descent parachute; and
an extraction force transfer coupling link assembly that initially connects to one end of the cargo extraction line for force transfer between the extraction parachute and a cargo load, and that includes a first separation device adapted to separate the extraction line from the link assembly.

2. The assembly according to claim 1, wherein the cargo extraction line and descent parachute deployment lanyard rope is of a single piece construction.

3. The assembly according to claim 1, wherein the cargo extraction line and descent parachute deployment lanyard rope is of a braided construction.

4. The assembly according to claim 1, wherein the rope has an elongation under load of from approximately 3% to approximately 5%.

5. The assembly according to claim 1, wherein the rope is constructed of a plurality of strands of an ultra high molecular weight polyethylene.

6. The assembly according to claim 1, further comprising a second separation device adapted to separate the deployment lanyard from the link assembly, said first separation device and said second separation device each including a pyrotechnic cutter.

7. The assembly according to claim 6, wherein said cargo extraction line and said descent parachute deployment lanyard are joined to one another by a braided connection, said first separation device being configured during a normal extraction to sever the extraction line at a point between the link assembly and the braided connection, thereby transferring the extraction force to the deployment lanyard so as to deploy the descent parachute.

8. The assembly according to claim 7, wherein, during a failed extraction, the second separation device is configured to sever the deployment lanyard so as to jettison the extraction parachute.

9. The assembly according to claim 8, wherein the assembly includes a timing device such that the second separation device severs the deployment lanyard before the first separation device severs the extraction line.

10. The assembly according to claim 8, further comprising an electronic control system that coordinates the operation of the first separation device and the second separation device.

11. The system according to claim 10, wherein the electronic control system includes an actuator, a power management circuit, a timing circuit for setting a time delay following initiation of said actuator, and a firing circuit, said power management circuit being configured to trigger said firing circuit for activation of said first separation device following said actuator initiation and said time delay.

12. The system according to claim 11, wherein said actuator includes a switch that closes in response to movement indicating exit of said cargo load from the aircraft.

13. The system according to claim 11, wherein said control system includes a second actuator, said power management circuit being further configured to trigger activation of said second separation device in response to initiation of said second actuator.

14. A cargo extraction and parachute deployment control system comprising:
an extraction parachute;
a descent parachute; and
an extraction force transfer coupling and extraction parachute jettison system configured to extract cargo from an airborne aircraft using said extraction parachute and then to deploy the cargo using said descent parachute, said extraction force transfer coupling and extraction parachute jettison system including,
a link assembly coupled to a cargo load platform and equipped with first and second pyrotechnic cutters;
an extraction line and deployment lanyard rope adapted to connect to said extraction parachute and to said descent parachute, said rope including an extraction line coupled to said link assembly through said first pyrotechnic cutters and a deployment lanyard coupled to said link assembly through said second pyrotechnic cutters; and
an electronic control system that coordinates operation of said first and second pyrotechnic cutters to sever said extraction line and said deployment lanyard, respectively.

15. The system according to claim 14, wherein the electronic control system includes an actuator, a power management circuit, a timing circuit for setting a time delay following initiation of said actuator, and a firing circuit, said power management circuit being configured to trigger said firing circuit for activation of said first separation device following said actuator initiation and said time delay.

16. The system according to claim 14, wherein said actuator includes a switch that closes in response to movement indicating exit of said cargo load from the aircraft.

17. The system according to claim 14, wherein said control system includes a second actuator, said power management circuit being further configured to trigger activation of said second separation device in response to initiation of said second actuator.

18. A method of deploying an airborne cargo, comprising:
connecting a rope that includes a cargo extraction line and a descent parachute deployment lanyard to an extraction parachute and to a descent parachute;
connecting another end of the cargo extraction line to an extraction force transfer coupling link assembly that includes a first separation device adapted to separate the extraction line from the link assembly, and a second separation device adapted to separate the deployment lanyard from the link assembly;
deploying the extraction parachute to extract the cargo; and
actuating the first separation device during a normal extraction so as to separate the extraction line from the link assembly, thereby transferring the extraction force to the deployment lanyard and deploying the descent parachute.

19. The method according to claim 18, further comprising actuating the second separation device during a failed extraction so as to separate the deployment lanyard from the link assembly, thereby jettisoning the extraction parachute.

20. The method according to claim 19, wherein the step of separating the extraction line from the link assembly and the step of separating the deployment lanyard from the link assembly are effected using pyrotechnic cutters.
